(19) United States
(12) Patent Application Publication
(10) Pub. No.: US 2009/0052102 A1
(43) Pub. Date: Feb. 26, 2009

(54) SEMICONDUCTOR DEVICE

(75) Inventor: Osamu WADA, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/193,871

(22) Filed: Aug. 19, 2008

(30) Foreign Application Priority Data
Aug. 20, 2007 (JP) 2007-213920
Dec. 19, 2007 (JP) 2007-326970

(51) Int. Cl. H02H 9/04

(52) U.S. Cl. 361/56

(57) ABSTRACT

A semiconductor device comprises a protection circuit for protecting a semiconductor integrated circuit. The protection circuit includes a first terminal supplied with a first voltage, a second terminal supplied with a second voltage lower than the first voltage, a first thyristor arranged between the first terminal and the second terminal, and a trigger circuit operative to break a current path for trigger current flowing in the first gate of the first thyristor when the first voltage is applied to the first terminal, thereby disabling the first thyristor to become conductive, and operative to form the current path for trigger current when a voltage other than the first voltage is applied to the first terminal, thereby enabling the first thyristor to become conductive. The trigger circuit includes a third terminal for controlling operation of the trigger circuit in accordance with the voltage on the first terminal, a switching element connected between the first gate of the first thyristor and the second terminal and having a control terminal connected to the third terminal, and a resistor connected between the third terminal and the second terminal.

### CROSS-REFERENCE TO RELATED APPLICATIONS

This application is based upon and claims the benefit of priority from the prior Japanese Patent Application No. 2007-213920, filed on Aug. 20, 2007, and the prior Japanese Patent Application No. 2007-326970, filed on Dec. 19, 2007, the entire contents of which are incorporated herein by reference.

### BACKGROUND OF THE INVENTION

1. Field of the Invention

The present invention relates to a semiconductor device capable of preventing breakage of elements on application of high voltages.

2. Description of the Related Art

Semiconductor devices such as LSIs include ESD (Electro-Static Discharge) protection circuits for protecting internal circuits from overcurrent caused by surges and so forth.

ESD protection circuits with various structures have been proposed and those including diodes and MOS transistors to protect internal circuits have been widely used. As highly integrated low-voltage semiconductor devices are developed, diodes and MOS transistors can not provide sufficient protections and ESD protection circuits using thyristors as protection elements have been proposed instead (see, for example, JP 2005-142432A). A thyristor is capable of fast switching and supplying a large current flow and is hardly destructed. Accordingly, the ESD protection circuits using thyristors have excellent characteristics such as high performance and high protectability.

Recent semiconductor devices are configured to necessarily include OTP (One Time Programmable) memories from which stored data can not be erased even after power-off. In particular, MOS-structured antifuses can be created through CMOS processes and are expected as storage elements for OTP memories used in suppressing increases in process cost.

The use of such the antifuse for programming in a short time requires a high voltage around 5-6 times a logic voltage. On the other hand, usually, shipping of semiconductor devices as products requires ESD protection circuits connected to external terminals on chips to prevent destruction of internal circuits due to overcurrent on transportation and assembly. The OTP memories using the antifuses as above, however, can not connect ESD protection circuits to external terminals that are supplied with high voltages required for data writing. This is because an operating voltage of the ESD protection circuit controlled lower than the program voltage (write voltage) disables application of the write voltage. In contrast, an operating voltage of the ESD protection circuit controlled higher than the program voltage (write voltage) disables protection of internal circuits before power-on, for example, on shipping.

### SUMMARY OF THE INVENTION

In an aspect the present invention provides a semiconductor device comprising a protection circuit for protecting a semiconductor integrated circuit, the protection circuit including a first terminal supplied with a first voltage, a second terminal supplied with a second voltage lower than the first voltage, a first thyristor arranged between the first terminal and the second terminal, and a trigger circuit operative to break a current path for trigger current flowing in the first gate of the first thyristor when the first voltage is applied to the first terminal, thereby disabling the first thyristor to become conductive, and operative to form the current path for trigger current when a voltage other than the first voltage is applied to the first terminal, thereby enabling the first thyristor to become conductive, the trigger circuit including a third terminal for controlling operation of the trigger circuit in accordance with the voltage on the first terminal, a switching element connected between the first gate of the first thyristor and the second terminal and having a control terminal connected to the third terminal, and a resistor connected between the third terminal and the second terminal.

### BRIEF DESCRIPTION OF THE DRAWINGS

FIG. 1 is a brief diagram of a semiconductor device according to a first embodiment of the present invention.

FIG. 2 is an illustrative view of voltages associated with operations of the semiconductor device according to the first embodiment of the present invention.

FIG. 3 is a brief diagram of a semiconductor device according to a second embodiment of the present invention.

FIG. 4 is a brief diagram of a semiconductor device according to a third embodiment of the present invention.

FIG. 5 is a brief diagram of a semiconductor device according to a fourth embodiment of the present invention.

FIG. 6 is a brief diagram of an internal circuit 5 in the semiconductor device according to the fourth embodiment of the present invention.

FIG. 7 is a brief diagram of a semiconductor device according to a fifth embodiment of the present invention.

FIG. 8 is a brief diagram of a semiconductor device according to a sixth embodiment of the present invention.

FIG. 9 is a brief diagram of a semiconductor device according to a seventh embodiment of the present invention.

FIG. 10 shows an example of the configuration of a protection circuit 107 in the semiconductor device according to the seventh embodiment of the present invention.

FIG. 11 shows an example of the configuration of a protection circuit 107 in the semiconductor device according to the seventh embodiment of the present invention.

FIG. 12 is a brief diagram showing an alternative of the semiconductor device according to the seventh embodiment of the present invention.

### DETAILED DESCRIPTION OF THE EMBODIMENTS

The embodiments associated with the semiconductor device of the present invention will now be described with reference to the drawings.

### First Embodiment

### Configuration of First Embodiment

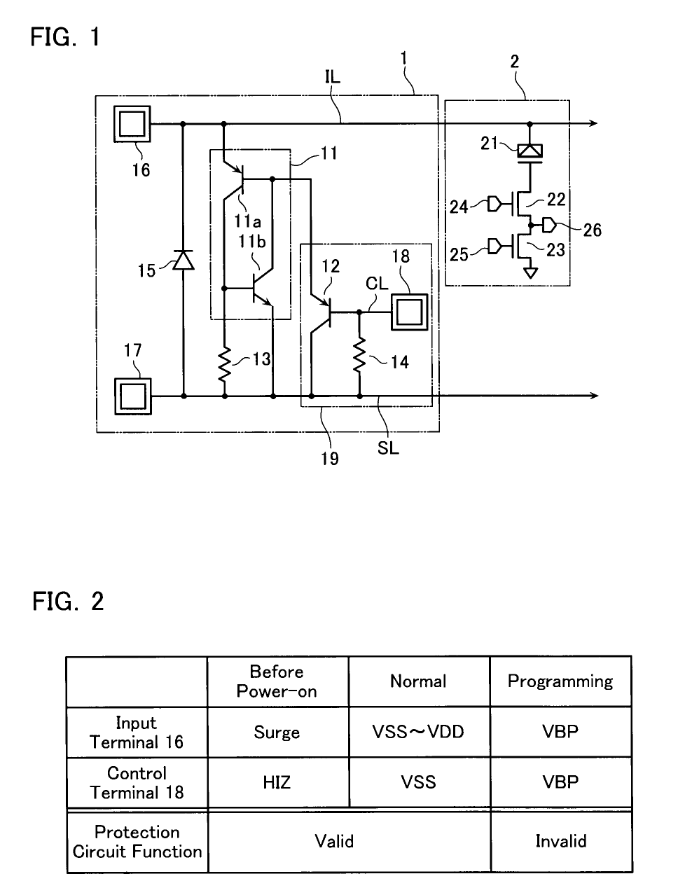

With reference to FIG. 1, a configuration of the semiconductor device according to a first embodiment of the present invention is described. FIG. 1 shows a brief diagram of the semiconductor device according to the first embodiment of the present invention. As shown in FIG. 1, the semiconductor device according to the first embodiment mainly comprises an ESD protection circuit 1, and an OTP memory 2. For simplifying the following description, a single memory cell is depicted in FIG. 1 representatively as the OTP memory.

The ESD protection circuit 1 is a circuit for protecting the OTP memory 2 from overcurrent, which is an example of the protection target or a semiconductor integrated circuit. It includes a thyristor (first thyristor) 11, a switching element 12, a resistor 13, a resistor 14, and a diode (first diode) 15. The ESD protection circuit 1 has an input terminal (first terminal) 16, a ground terminal (second terminal) 17, and a control terminal (third terminal) 18.

The input terminal 16 is a terminal for applying a write voltage (first voltage) VBP to the OTP memory 2. The write voltage VBP may be 5 V or higher or 5-7 V. The input terminal 16 is supplied with a lower or higher voltage other than the write voltage VBP before power-on or at the time of reading. The input terminal 16 is connected to an input line IL. The input terminal 16 may also be supplied with a drive voltage for use in driving other circuits, in addition to the write voltage VBP.

The ground terminal 17 is supplied with the ground voltage (second voltage) VSS and connected to a ground line SL.

The control terminal 18 is supplied with a voltage for controlling the switching element 12 and connected to a control line CL.

The thyristor 11 comprises a PNP bipolar transistor 11a and an NPN bipolar transistor 11b in this example.

The PNP bipolar transistor 11a has an emitter connected to the input line IL. The PNP bipolar transistor 11a has a collector connected to the ground line SL via the resistor 13. The PNP bipolar transistor 11a has a base connected to the emitter of the switching element 12 described later.

The NPN bipolar transistor 11b has an emitter connected to the ground line SL. The NPN bipolar transistor 11b has a collector connected to the base of the PNP bipolar transistor 11a. The NPN bipolar transistor 11b has a base connected to the collector of the PNP bipolar transistor 11a.

In a word, the thyristor 11 has a first and a second gate, an anode, and a cathode. The anode of the thyristor 11 (the emitter of the PNP bipolar transistor 11a) is connected to the input line IL. The second gate of the thyristor 11 (the base of the NPN bipolar transistor 11b) is connected to the ground line SL via the resistor 13. The first gate of the thyristor 11 (the base of the PNP bipolar transistor 11a) is connected to the switching element 12. The cathode of the thyristor 11 (the emitter of the NPN bipolar transistor 11b) is connected to the ground line SL.

The switching element 12 comprises a PNP bipolar transistor, of which emitter is connected to the base of the PNP bipolar transistor 11a described above. The switching element 12 has a collector connected to the ground line SL and a base connected to the control line CL.

The resistor 13 is arranged between the base of the NPN bipolar transistor 11b (the second gate of the thyristor 11) and the ground line SL (the ground terminal 17).

The resistor 14 is arranged between the control line CL and the ground line SL.

The diode 15 has a cathode connected to the input line IL (the input terminal 16). The diode 15 has an anode connected to the ground line SL (the ground terminal 17). The diode 15 is arranged in the forward direction from the ground line SL (the ground terminal 17) toward the input line IL (the input terminal 16).

The switching element 12, the resistor 14 and the control terminal 18 described above serve as a trigger circuit 19 operative to determine whether the thyristor 11 is in the state of conduction.

The OTP memory 2 includes an antifuse 21, NMOS transistors 22, 23, a first control terminal 24, a second control terminal 25, and an output terminal 26.

The antifuse 21 comprises a PMOS transistor having a source and a drain terminal mutually connected. The antifuse 21 includes an insulator formed thinner than the NMOS transistors 22, 23.

The source/drain of the antifuse 21 is connected to the input line IL. The antifuse 21 has a gate connected to one end (drain) of the NMOS transistor 22. The other end (source) of the NMOS transistor 22 is connected to one end (drain) of the NMOS transistor 23. The other end (source) of the NMOS transistor 23 is grounded. The gate of the NMOS transistor 22 is connected to the first control terminal 24. The gate of the NMOS transistor 23 is connected to the second control terminal 25. Anode between the NMOS transistor 22 and the NMOS transistor 23 is connected to the output terminal 26 for data reading.

The first control terminal 24 is used in controlling the gate of the NMOS transistor 22 to restrict the voltage applied to the node between the NMOS transistors 22, 23, thereby suppressing the high voltage applied to the NMOS transistor 23. The second control terminal 25 is used in controlling the NMOS transistor 23 to write data in the antifuse 21 or read data from the antifuse 21.

### (Operation of ESD Protection Circuit 1 of First Embodiment)

With reference to FIGS. 1 and 2, operation of the ESD protection circuit according to the first embodiment of the present invention is described next. FIG. 2 shows conditions on operation of the ESD protection circuit according to the first embodiment of the present invention.

A surge may be applied to the input terminal 16 before power-on. This case is described first. In such the case, the control terminal 18 is brought into the state of high-impedance (HIZ). On the other hand, the base of the switching element 12 is connected to the ground terminal 17 through the resistor 14 and kept at the ground potential.

Therefore, the switching element 12 is turned on. Thus, current can flow from the input terminal 16 through the PNP bipolar transistor 11a and the switching element 12 to the ground terminal 17. In a word, on the basis of a voltage (trigger voltage) determined by the forward voltage Vf of the PNP bipolar transistor 11a and the switching element 12, trigger current is supplied in the thyristor 11. The trigger current activates the thyristor 11 and the thyristor 11 makes a short circuit between the input terminal 16 and the ground terminal 17 to dissipate the surge, thereby protecting internal circuits such as the OTP memory 2 (validating the protection circuit function).

Programming the OTP memory 2 is described next. In such the case, the control terminal 18 is supplied with the write voltage VBP. Thus, the switching element 12 is turned off to break the current path for current flowing from the input terminal 16 through the PNP bipolar transistor 11a and the switching element 12 to the ground terminal 17. Therefore, the thyristor 11 can not be activated and the input terminal 16 can be used in supplying the high voltage VBP to internal circuits such as the OTP memory 2. In other words, the protection circuit function is invalidated on programming.

The following description is given to normal operation of the OTP memory 2 (including reading) other than programming. In such the case, the control terminal 18 is kept at the ground potential VSS. In a word, the switching element 12 is turned on to validate the protection circuit function in normal operation similar to the state before power-on. At normal time, the input terminal 16 is supplied with such a voltage (for example, the supply voltage VDD) that is higher than the ground voltage and lower than the high voltage VBP.

### (Programming (Writing) OTP Memory 1 of First Embodiment)

With reference to FIG. 1, programming (writing) the OTP Memory 1 of the first embodiment according to the present invention is described next.

On programming, the input terminal 16 is initially given the high-voltage VBP. As described above, the protection circuit function of the ESD protection circuit 1 is invalidated on programming. Accordingly, the high voltage VBP can be applied to one end of the antifuse 21. The first control terminal 24 is given a middle voltage between the ground voltage VSS and the high voltage VBP to protect the NMOS transistor 23. The second control terminal 25 is given the ground voltage VSS.

Subsequently, the voltage applied to the second control terminal 25 is elevated from the ground voltage VSS to the supply voltage VDD or the high voltage VBP. Thus, the NMOS transistor 23 is turned on and the high voltage VBP is applied across the antifuse 21 to destruct the insulator in the antifuse 21. In a word, the antifuse 21 is programmed.

As described above, in the semiconductor device according to the first embodiment of the present invention, the thyristor 11 contained in the ESD protection circuit 1 includes the switching element 12, the control terminal 18 for controlling the switching element 12, and the resistor 14. In a word, the semiconductor device according to the first embodiment of the present invention includes a trigger circuit 19 operative to control operation of the thyristor 11. The trigger circuit 19 breaks a current path for current (trigger current) flowing in the first gate of the thyristor 11 when the write voltage VBP is applied to the input terminal 16, thereby disabling the thyristor 11 to become conductive. On the other hand, the trigger circuit 19 forms the current path for trigger current when a voltage other than the write voltage VBP is applied to the input terminal 16, thereby enabling the thyristor 11 to become conductive.

The semiconductor device according to the first embodiment of the present invention validates the function of the ESD protection circuit 1 before power-on, for example, at the time of shipping, and when a voltage (other than the first voltage) for use in reading and so forth is applied to the input terminal 16. In contrast, it invalidates the function of the ESD protection circuit 1 when a high voltage (first voltage) for use in writing is applied to the input terminal 16 in a switchable manner.

### Second Embodiment

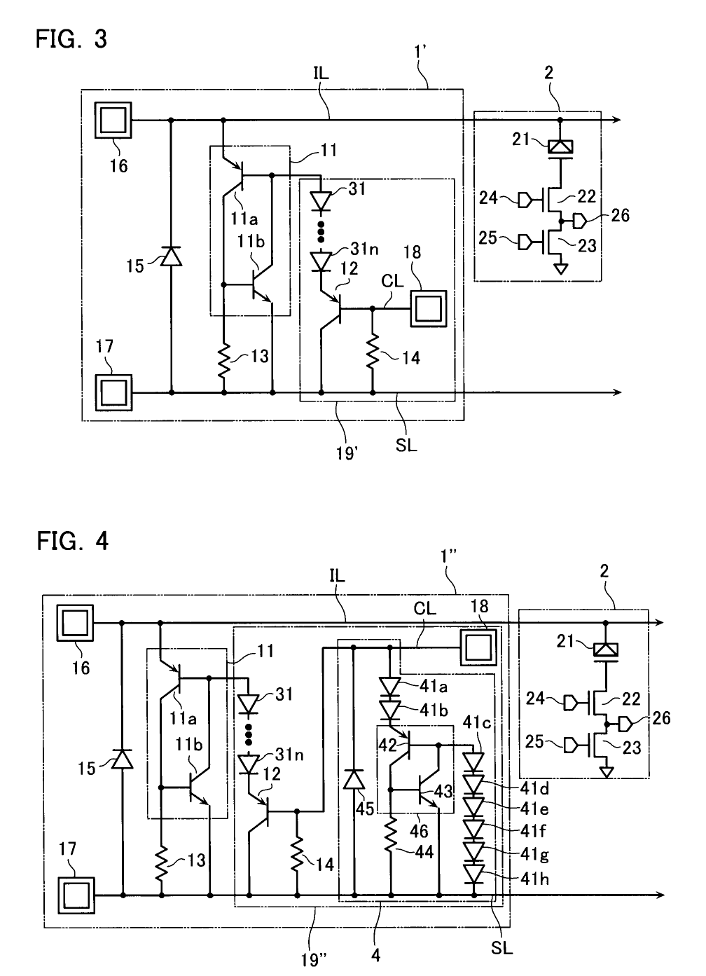

With reference to FIG. 3, a configuration of the semiconductor device according to a second embodiment of the present invention is described next. FIG. 3 shows a brief diagram of the semiconductor device according to the second embodiment of the present invention. As shown in FIG. 3, the semiconductor device according to the second embodiment mainly comprises an ESD protection circuit 1′, and an OTP memory 2. The same elements in the semiconductor device according to the second embodiment as those in the first embodiment are denoted with the same reference numerals and omitted from the following description.

In the semiconductor device according to the second embodiment, a trigger circuit 19′ in the ESD protection circuit 1′ has a different configuration from the first embodiment. The trigger circuit 19′ includes two or more serially connected diodes (second diodes) 31-31n in addition to the configuration of the first embodiment. The diodes 31-31n are serially connected between the base of the PNP bipolar transistor 11a (the first gate of the thyristor 11) and the emitter of the switching element 12. The diodes 31-31n are arranged in the forward direction from the first gate of the thyristor 11 toward the switching element 12.

As the semiconductor device according to the second embodiment has the above configuration, the number of the diodes 31-31n operating as the trigger circuit 19′ can vary the trigger voltage for activating the thyristor 11. Thus, it is possible to set an appropriate protection voltage in accordance with the thickness of the insulator in the antifuse 21. Operation thereof is same as in the first embodiment and omitted from the following description.

### Third Embodiment

With reference to FIG. 4, a configuration of the semiconductor device according to a third embodiment of the present invention is described next. FIG. 4 shows a brief diagram of the semiconductor device according to the third embodiment of the present invention. As shown in FIG. 4, the semiconductor device according to the third embodiment mainly comprises an ESD protection circuit 1″, and an OTP memory 2. The same elements in the semiconductor device according to the third embodiment as those in the first embodiment are denoted with the same reference numerals and omitted from the following description.

In the semiconductor device according to the third embodiment, a trigger circuit 19″ in the ESD protection circuit 1″ has a different configuration from the second embodiment. The trigger circuit 19″ includes a control-terminal protection circuit 4 in addition to the configuration of the second embodiment. The control-terminal protection circuit 4 is arranged between the control line CL and the ground line SL.

The control-terminal protection circuit 4 includes eight diodes 41a-41h (diodes (fifth diodes) 41a, 41b, and diodes 41c-41h (fourth diodes)), a PNP bipolar transistor 42, an NPN bipolar transistor 43, a resistor 44, and a diode (third diode) 45. The PNP bipolar transistor 42 and the NPN bipolar transistor 43 configure a thyristor (second thyristor) 46.

The PNP bipolar transistor 42 has an emitter (the anode of the thyristor 46) connected via two diodes 41a, 41b to the control line CL. The two diodes 41a, 41b have cathodes connected toward the PNP bipolar transistor 42. The diodes 41a, 41b are arranged in the forward direction from the control line CL toward the emitter of the PNP bipolar transistor 42 (the anode of the thyristor 46).

The PNP bipolar transistor 42 has a collector (the second gate of the thyristor 46) connected via the resistor 44 to the ground line SL (the ground terminal 17). The PNP bipolar transistor 42 has a base (the first gate of the thyristor 46) connected via six serially connected diodes 41c-41h to the ground line SL (the ground terminal 17). The diodes 41c-41h are arranged in the forward direction from the base of the PNP bipolar transistor 42 (the first gate of the thyristor 46) to the ground line SL (the ground terminal 17).

The NPN bipolar transistor 43 has an emitter (the cathode of the thyristor 46) connected to the ground line SL. The NPN bipolar transistor 43 has a collector connected to the base of the PNP bipolar transistor 42. The NPN bipolar transistor 43 has a base connected to a node between the collector of the PNP bipolar transistor 42 and the resistor 44.

The diode 45 is arranged between the control line CL (the control terminal 18) and the ground line SL (the ground terminal 17). The diode 45 is arranged in the forward direction from the ground line SL (the ground terminal 17) to the control line CL (the control terminal 18).

In the semiconductor device according to the third embodiment, a higher voltage than a certain value applied to the control terminal 18 turns on the thyristor 46 composed of the PNP bipolar transistor 42 and the NPN bipolar transistor 43. As a result, the control terminal 18 is electrically connected to the ground terminal 17 to dissipate the high voltage, thereby protecting internal circuits. In the embodiment shown in FIG. 4, if the diodes 41a-41h and the PNP bipolar transistor 42 have a threshold voltage of 1 V each, the control-terminal protection circuit 4 can protect the control terminal 18 from a high voltage of 9 V or higher.

As the semiconductor device according to the third embodiment is operable as above, it allows the control terminal 18 to be shared by other signals for use in internal circuits.

### Fourth Embodiment

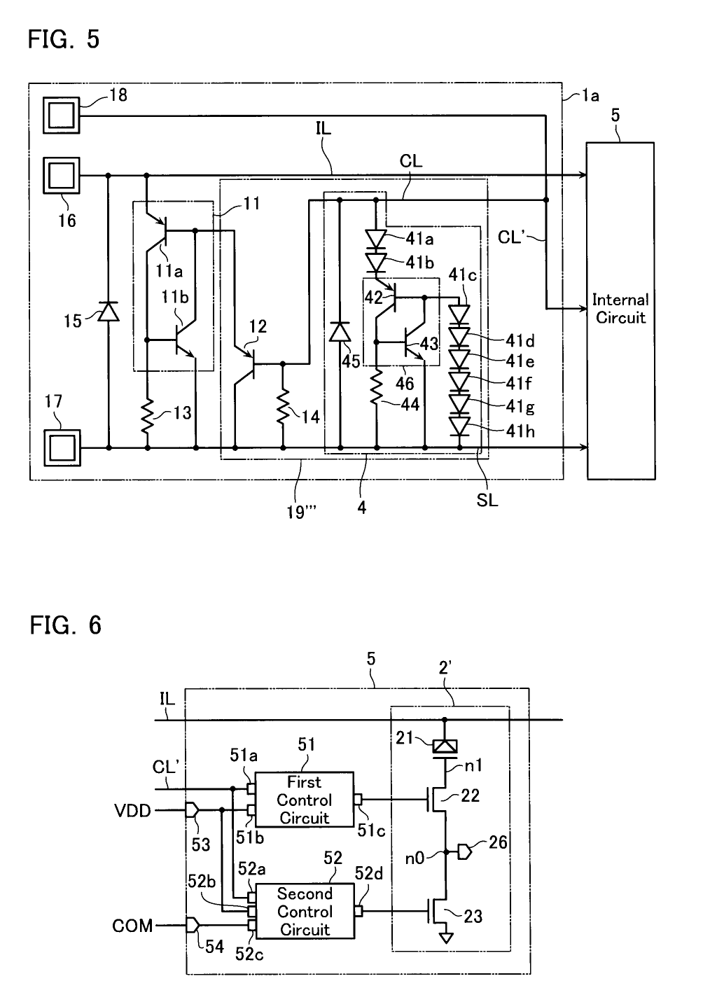

With reference to FIGS. 5 and 6, a configuration of the semiconductor device according to a fourth embodiment of the present invention is described next. FIG. 5 shows a brief diagram of the semiconductor device according to the fourth embodiment of the present invention. FIG. 6 shows a brief diagram of an internal circuit 5. As shown in FIG. 5, the semiconductor device according to the fourth embodiment mainly comprises an ESD protection circuit 1a, and an internal circuit 5 including an OTP memory 2′. The same elements in the semiconductor device according to the fourth embodiment as those in the first through third embodiment are denoted with the same reference numerals and omitted from the following description.

The ESD protection circuit 1a according to the fourth embodiment is not provided with the diodes 31-31n, different from the ESD protection circuit 1″ of the third embodiment. In a word, in the fourth embodiment a trigger circuit 19′″ is different from the trigger circuit 19″ of the third embodiment. In the ESD protection circuit 1a, a first branch control line CL′ branched from the control line CL is connected to the internal circuit 5. In addition, the input line IL and the ground line SL are connected to the internal circuit 5, like the above embodiments.

The internal circuit 5 includes an OTP memory 2′ having one end connected to the input line IL, a first control circuit 51 operative to generate a certain voltage, and a second control circuit 52.

In the OTP memory 2′, the antifuse 21 has one end connected to the input line IL and the other end connected to one end of the NMOS transistor 22, like in the first through third embodiments. An output terminal 26 is arranged between the NMOS transistors 22, 23. The position at which the output terminal 26 is connected is referred to as a node n0, and the position connecting the antifuse 21 with the NMOS transistor 22 is referred to as a node n1. A 1-bit OTP memory 2′ is exemplified in the figure though actually plural such OTP memories 2′ are present in parallel.

The first control circuit 51 is used in generating from the supply voltage VDD a voltage required to turn on the gate of the NMOS transistor 22 and comprises, for example, multistage charge pump circuits. The first control circuit 51 has a first input terminal 51a connected to the first branch control line CL′ and a second input terminal 51b given the supply voltage VDD from a supply voltage terminal 53. The first control circuit 51 has an output terminal 51c connected to the gate of the NMOS transistor 22.

The second control circuit 52 is a logic circuit for controlling the OTP memory 2′. The second control circuit 52 has a first input terminal 52a connected to the first control line CL′ and a second input terminal 52b given the supply voltage VDD from the supply voltage terminal 53. The second control circuit 52 has a third input terminal 52c given a command signal COM from a command signal input terminal 54. The second control circuit 52 has an output terminal 52c connected to the gate of the NMOS transistor 23.

Operation of the semiconductor device according to the fourth embodiment is described next.

First, on the basis of the potential on the first branch control line CL′, the first control circuit 51 elevates the potential given to the gate of the NMOS transistor 22 to an appropriate voltage between the supply voltage VDD and the high voltage VBP for program use. In a word, the NMOS transistor 22 turns on. The second control circuit 52 controls the potential given to the gate the NMOS transistor 23 to the ground potential. Such the operation makes the OTP memory 2′ programmable.

Next, the high voltage VBP is applied from the control terminal 18 via the input line IL to the source, drain and back gate of the antifuse 21. In addition, on the basis of the input of the command signal COM from the command signal input terminal 52c, the second control circuit 52 elevates the potential given to the gate of the NMOS transistor 23 from the ground potential to the supply voltage VDD. As a result, the NMOS transistor 23 turns onto pull the nodes n0 and n1 down to the ground potential. Thus, the high voltage VBP is applied to the gate oxide in the antifuse 21 to destruct the gate oxide.

Such the configuration has a mode of applying a high voltage to the input terminal 16, for example, to program the OTP memory 2′ in the internal circuit S. In this case, the control terminal 18 is supplied with the same voltage VBP as the high voltage VBP applied to the input terminal 16 and the ground terminal 17 is kept at the ground potential VSS. When the switching element 12 is turned off, programming is executed in the internal circuit 5. At this time, the ESD protection circuit 1a breaks the current path for current flowing from the input terminal 16 through the PNP bipolar transistor 11a and the switching element 12 to the ground terminal 17. Accordingly, the thyristor 11 is not activated and thus the high voltage VBP can be applied to the input terminal 16.

On the other hand, at normal time, the control terminal 18 is kept at the ground potential VSS. In this case, programming is not executed in the internal circuit 5, and the switching element 12 is turned on to validate the protection circuit function.

As described above, the semiconductor device according to the fourth embodiment is capable of switching the protection function in accordance with the input voltage. In addition, in the semiconductor device according to the fourth embodiment, the control terminal 18 can be shared by the control signal to the ESD protection circuit 1a and the signal to the internal circuit 5, thereby suppressing the increase in the number of external terminals.

### Fifth Embodiment

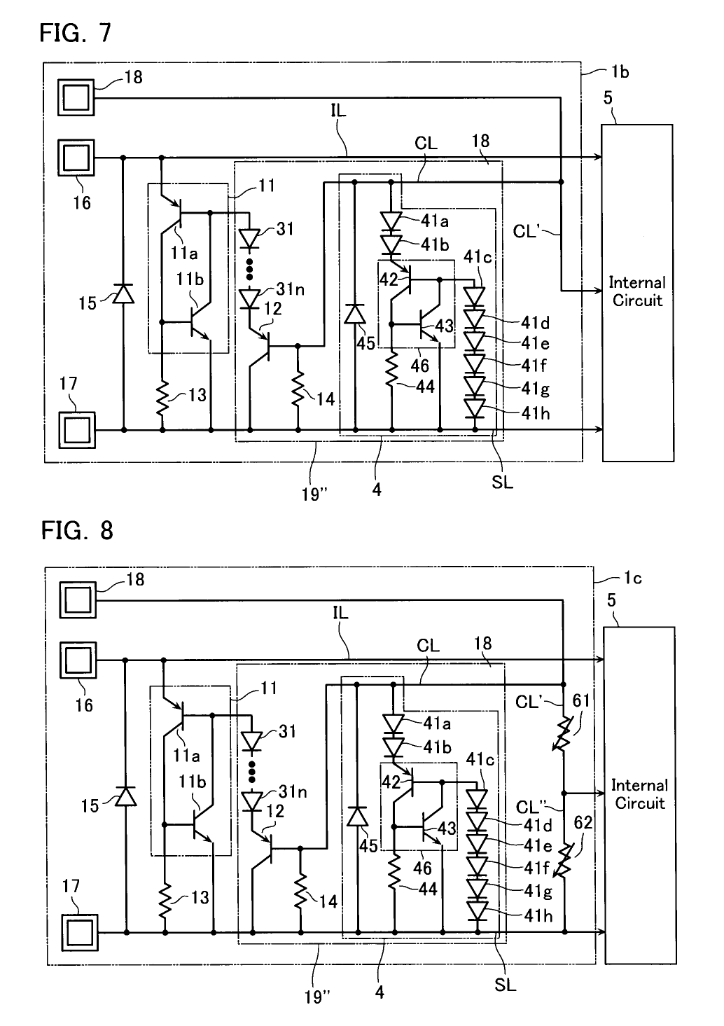

With reference to FIG. 7, a configuration of the semiconductor device according to a fifth embodiment of the present invention is described next. FIG. 7 shows a brief diagram of the semiconductor device according to the fifth embodiment of the present invention. As shown in FIG. 7, the semiconductor device according to the fifth embodiment mainly comprises an ESD protection circuit 1b, and an internal circuit 5. The same elements in the semiconductor device according to the fifth embodiment as those in the first through fourth embodiments are denoted with the same reference numerals and omitted from the following description.

The ESD protection circuit 1b includes diodes 31-31n between the base of the PNP transistor 11a and the emitter of the PNP transistor 11b, different from the fourth embodiment. The trigger circuit 19″ according to the fifth embodiment is same as that of the third embodiment. The total number (n) of the diodes 31-31n determines the trigger voltage for activating the thyristor 11.

The semiconductor device according to the fifth embodiment has the above configuration and accordingly can exert the same effect as the fourth embodiment. In addition, the semiconductor device according to the fifth embodiment includes the diodes 31-31n and accordingly can set an appropriate protection voltage in accordance with the film thickness of the transistor used in the internal circuit 5.

### Sixth Embodiment

With reference to FIG. 8, a configuration of the semiconductor device according to a sixth embodiment of the present invention is described next. FIG. 8 shows a brief diagram of the semiconductor device according to the sixth embodiment of the present invention. As shown in FIG. 8, the semiconductor device according to the sixth embodiment mainly comprises an ESD protection circuit 1c, and an internal circuit 5. The same elements in the semiconductor device according to the sixth embodiment as those in the first through fifth embodiments are denoted with the same reference numerals and omitted from the following description.

The ESD protection circuit 1c includes a second branch control line CL″ connecting the first branch control line CL′ with the ground line SL. The first and second branch control lines CL′, CL″ include resistors 61, 62.

The above resistors 61, 62 feed a voltage signal divided at an appropriate ratio to the internal circuit 5 via the first branch control line CL′. The first branch control line CL′ may include a buffer such as an inverter to feed the output signal therefrom to the internal circuit 5.

The semiconductor device according to the sixth embodiment has the above configuration and accordingly can exert the same effects as the fourth and fifth embodiments. In addition, the semiconductor device according to the sixth embodiment includes the resistors 61, 62 contained in the first and second branch control lines CL′, CL″. Accordingly, the voltage signal divided by the resistors 61, 62 can be used as a circuit signal operable at a logic voltage in the internal circuit 5.

### Seventh Embodiment

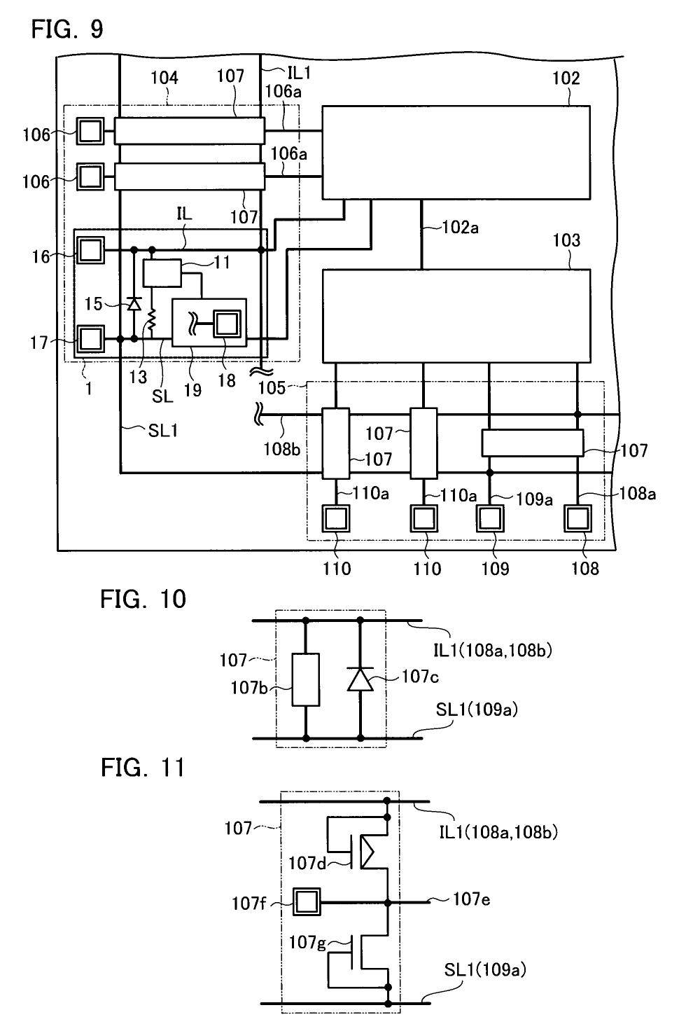

With reference to FIG. 9, a configuration of the semiconductor device according to a seventh embodiment of the present invention is described next. FIG. 9 shows a brief diagram of the semiconductor device according to the seventh embodiment of the present invention. The same elements in the semiconductor device according to the seventh embodiment as those in the first through sixth embodiments are denoted with the same reference numerals and omitted from the following description.

The semiconductor device according to the seventh embodiment includes a first internal circuit 102, a second internal circuit 103, a first drive-voltage control circuit 104, and a second drive-voltage control circuit 105 as shown in FIG. 9.

The first internal circuit 102 is driven by a high-voltage power source (for example, 3-5 V). The second internal circuit 103 is driven at a lower voltage (for example, 1-1.8 V) than the internal circuit 102. The first internal circuit 102 is connected via a control line 102a to the second internal circuit 103.

The first drive-voltage control circuit 104 controls the drive voltage to the first internal circuit 102. The first drive-voltage control circuit 104 includes an ESD protection circuit 1 similar to that in the first embodiment, two first external terminals 106, and two protection circuits 107.

In the ESD protection circuit 1, the input terminal 16 is supplied with the drive voltage for driving the first internal circuit 102. The ground terminal 17 is supplied with the ground voltage and the control terminal 18 is supplied with the voltage for controlling the switching element 12, like in the first embodiment. The input line IL is connected to a branch input line IL1 at a node on a certain position. The ground line SL is connected to a branch ground line SL1 at a node on a certain position.

The first external terminals 106 are used in feeding external signals via external terminal lines 106a and the protection circuits 107 to the first internal circuit 102.

The protection circuits 107 are supplied with the drive voltage via the branch input line IL1. In addition, the protection circuits 107 are supplied with the ground voltage via the branch ground line SL1. The protection circuit 107 includes a protection circuit body 107b arranged between the branch input line IL1 and the branch ground line SL1, and a diode protection element 107c arranged in the forward direction from the branch ground line SL1 toward the branch input line IL1. The protection circuit body 107b is composed of a thyristor or the like and operative to adjust the voltage for activating the thyristor in accordance with the applied voltage.

The second drive-voltage control circuit 105 controls the drive voltage for the second internal circuit 103. The second drive-voltage control circuit 105 includes a voltage source terminal 108, a ground terminal 109, three protection circuits 107, and two second external terminals 110.

The voltage source terminal 108 is used in applying the drive voltage via a voltage source line 108a to the second internal circuit 103. The ground terminal 109 is used in applying the ground voltage via a ground line 109a to the second internal circuit 103. The voltage source line 108a is connected to a branch voltage source line 108b at a node on a certain position. The ground line 109a is connected to the above-described branch ground line SL1 at a node on a certain position.

A protection circuit 107 is arranged between the voltage source line 108a and the ground line 109a. As shown in FIG. 10, in the protection circuit 107 arranged between the voltage source line 108a and the ground line 109a, the diode protection element 107c is arranged in the forward direction from the ground line 109a to the voltage source line 108a.

The second external terminals 110 are used in applying external signals via external terminal lines 110a and protection circuits 107 to the second internal circuit 103. The protection circuits 107 arranged in relation to the external terminal lines 110a are connected to the branch ground line SL1 and a branch voltage source line 108b. As shown in FIG. 10, in the protection circuits 107 arranged between the branch voltage source line 108b and the branch ground line SL1, the diode protection element 107c is arranged in the forward direction from the branch ground line SL1 to the branch voltage source line 108b.

In the above seventh embodiment the protection circuit 107 is configured as shown in FIG. 10 though it may also be configured as shown in FIG. 11. Namely, the protection circuit 107 shown in FIG. 11 includes a p-type transistor 107d having a source connected to the branch input line IL1 (the voltage source line 108a, the branch voltage source line 108b), a control line 107e connected to the drain of the p-type transistor 107d, a terminal 107f connected to the control line 107e, and an n-type transistor 107g having a drain connected to the control line 107e. The n-type transistor 107g has a source connected to the branch ground line SL1 (the ground line 109a). The gate and the source of the p-type transistor 107d are commonly connected (diode-connected). The gate and the source of the n-type transistor 107g are commonly connected (diode-connected). The terminal 107f is supplied with a certain pre-determined voltage.

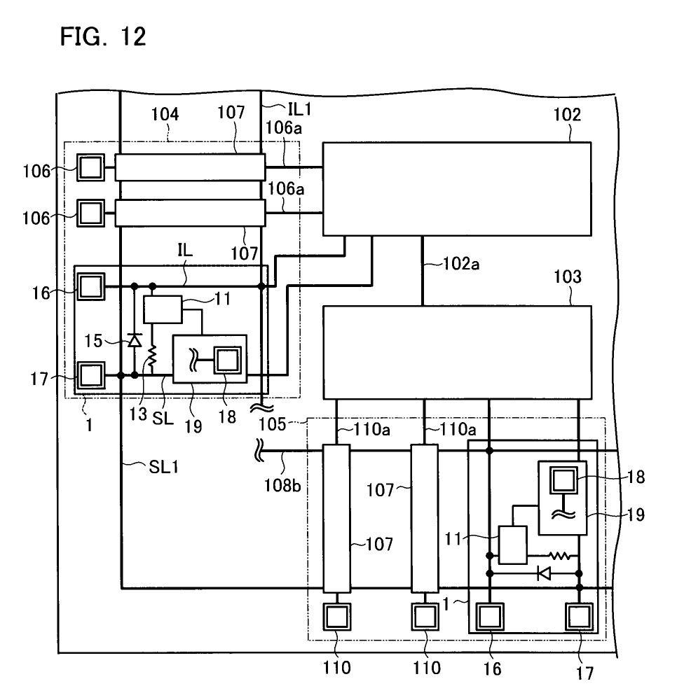

In the above seventh embodiment, FIG. 9 shows the first drive-voltage control circuit 104 arranged only in the ESD protection circuit 1 though the above seventh embodiment may also be configured as shown in FIG. 12. Namely, in the second drive-voltage control circuit 105, the protection circuits 107 configured as shown in FIG. 9 and connected to the voltage source terminal 108, the ground terminal 109, the voltage source line 108a and the ground line 109a may be replaced by an ESD protection circuit 1 as shown in FIG. 12.

In the above seventh embodiment, FIG. 9 shows the semiconductor device integrated on the same chip though it is not limited to that but may be another semiconductor device such as a FPGA (Field Programmable Gate Array) using multiple power sources.

The ESD protection circuits 1′, 1″, 1a, 1b, 1c used in the second through sixth embodiments may be applied in the above seventh embodiment in place of the ESD protection circuit 1.

The semiconductor device according to the seventh embodiment includes the ESD protection circuit 1. Therefore, it is possible to prevent destruction of the transistor in the first internal circuit 102.

The following consideration is given to a comparison example including a high-voltage protection circuit that can be activated with a voltage 1.5-2 times the high-voltage power source in place of the ESD protection circuit 1 in the semiconductor device according to the seventh embodiment. In such the comparison example, if a surge occurs on the input line IL due to static discharge or the like, a surge noise arises on the input line IL. Subsequently, before the high-voltage protection circuit is activated, the surge noise is transmitted by coupling as the signal on the control signal line 102a or the signal input to the second internal circuit 103. The surge noise may destruct the transistor in the second internal circuit 103 disadvantageously.

In contrast, the semiconductor device according to the seventh embodiment includes the ESD protection circuit 1, different from the comparison example. Accordingly, it is possible to dissipate the surge noise and protect the second internal circuit 103.

The above embodiments also show the following configurations (1), (2).

(1) A semiconductor device comprising the trigger circuit 19′ (or 19″), which includes one or two or more serially connected diodes 31-31n arranged between the first gate of the thyristor 11 and one end of the switching element 12.

(2) A semiconductor device in which the voltage (second voltage) applied to the ground terminal (second terminal) is the ground potential.

What is claimed is:

1. A semiconductor device comprising a protection circuit for protecting a semiconductor integrated circuit, said protection circuit including
a first terminal supplied with a first voltage,
a second terminal supplied with a second voltage lower than said first voltage,
a first thyristor arranged between said first terminal and said second terminal, and
a trigger circuit operative to break a current path for trigger current flowing in the first gate of said first thyristor when said first voltage is applied to said first terminal, thereby disabling said first thyristor to become conductive, and operative to form said current path for trigger current when a voltage other than said first voltage is applied to said first terminal, thereby enabling said first thyristor to become conductive,
said trigger circuit including
a third terminal for controlling operation of said trigger circuit in accordance with the voltage on said first terminal,
a switching element connected between the first gate of said first thyristor and said second terminal and having a control terminal connected to said third terminal, and
a resistor connected between said third terminal and said second terminal.

2. The semiconductor device according to claim 1, wherein said first voltage is applied to said third terminal when said first voltage is applied to said first terminal.

3. The semiconductor device according to claim 1, further comprising a third-terminal protection circuit operative to become conductive to electrically connect said third terminal to said second terminal when a higher voltage than a certain value is applied to said third terminal.

4. The semiconductor device according to claim 1, further comprising:
an antifuse having one end connected to said first terminal;
a first transistor having one end connected to the other end of said antifuse, and a gate controllable on the basis of a signal on said third terminal; and
a second transistor having one end connected to the other end of said first transistor, the other end grounded, and a gate controllable on the basis of a signal on said third terminal.

5. The semiconductor device according to claim 4, further comprising:
a connection line for connecting said third terminal to said second terminal; and
a plurality of resistors arranged in connection with said connection line,
wherein the gate of said first transistor and the gate of said second transistor are controlled with a voltage signal divided by said resistors on the basis of said signal on said third terminal.

6. The semiconductor device according to claim 1, further comprising a plurality of internal circuits operative on the basis of a signal received via said protection circuit.

7. The semiconductor device according to claim 6, wherein said protection circuit is provided in relation to each of said plurality of internal circuits.

8. The semiconductor device according to claim 1, further comprising a first diode arranged between said first terminal and said second terminal,
wherein said first diode is arranged in the forward direction from said second terminal toward said first terminal.

9. The semiconductor device according to claim 1, further comprising a resistor arranged between the second gate of said first thyristor and said second terminal.

10. The semiconductor device according to claim 1, wherein said trigger circuit includes one or two or more serially connected second diodes arranged between the first gate of said first thyristor and one end of said switching element,
wherein said second diodes are arranged in the forward direction from the first gate of said first thyristor toward said switching element.

11. The semiconductor device according to claim 1, wherein said second voltage applied to said second terminal is the ground potential.

12. The semiconductor device according to claim 3, wherein said third-terminal protection circuit includes a second thyristor arranged between said third terminal and said second terminal.

13. The semiconductor device according to claim 3, wherein said third-terminal protection circuit includes a third diode arranged between said third terminal and said second terminal,
wherein said third diode is arranged in the forward direction from said second terminal toward said third terminal.

14. The semiconductor device according to claim 12, wherein said third-terminal protection circuit includes one or two or more serially connected fourth diodes arranged between the first gate of said second thyristor and said second terminal,
wherein said fourth diodes are arranged in the forward direction from the first gate of said second thyristor toward said second terminal.

15. The semiconductor device according to claim 12, wherein said third-terminal protection circuit includes one or two or more serially connected fifth diodes arranged between the anode of said second thyristor and said third terminal,
wherein said fifth diodes are arranged in the forward direction from said third terminal toward the anode of said second thyristor.

16. The semiconductor device according to claim 12, said third-terminal protection circuit including a resistor arranged between the second gate of said second thyristor and said second terminal.
